(19) United States
(12) Patent Application Publication
(10) Pub. No.: US 2013/0181629 A1
(43) Pub. Date: Jul. 18, 2013

(54) DISCHARGE DEVICE

(71) Applicant: NGK Insulators, Ltd., Nagoya-City (JP)

(72) Inventors: Tomonori URUSHIHARA, Yokohama-City (JP); Wataru SHIONOYA, Okazaki-City (JP); Ryuta KONO, Nagoya-City (JP); Katsunori TANAKA, Nagoya-City (JP)

(73) Assignee: NGK INSULATORS, LTD., Nagoya-City (JP)

(21) Appl. No.: 13/727,918

(22) Filed: Dec. 27, 2012

Related U.S. Application Data
(60) Provisional application No. 61/580,454, filed on Dec. 27, 2011.

(51) Int. Cl. H05H 1/24

(52) U.S. Cl. CPC H05H 1/24
USPC 315/223

(57) ABSTRACT

A pulse controller performs a control to apply at least one high-energy first pulse P1 between a pair of electrodes in a first interval T1 to thereby promote a discharge breakdown between the pair of electrodes, and performs a control to apply at least two second pulses P2, which are lower in energy than the first pulse P1, between the pair of electrodes in a second interval T2 after the discharge breakdown has occurred between the pair of electrodes, to thereby maintain the discharge breakdown between the pair of electrodes.

### CROSS-REFERENCE TO RELATED APPLICATION

This application is based upon and claims the benefit of priority from U.S. Provisional Patent Application Ser. No. 61/580454 filed on Dec. 27, 2011, the contents of which are incorporated herein by reference.

### BACKGROUND OF THE INVENTION

1. Field of the Invention

The present invention relates to a discharge device for performing various processes (including a spark ignition process for internal combustion engines, a gas decomposing process, a deodorizing process, a plasma film growth process, a plasma etching process, a laser oscillation process, a gas generating process, etc.) using a plasma produced by an electric discharge of high-voltage pulses.

2. Description of the Related Art

Recently, technologies for deodorization, sterilization, film growth, toxic gas decomposition, ignition, etc., based on a plasma produced by a pulsed electric discharge have been developed (see, for example, Japanese Patent No. 2649340, and Applied Physics, Volume 61, No. 10, 1992, pp. 1039-1043, “Fabrication of an Amorphous Silicon Thin Film According to High-Voltage Pulsed Electric Discharge Chemical Vapor Deposition”). For efficiently performing a plasma-based process, it is necessary to supply high-voltage pulses having an extremely small width (see, for example, IEEE Transactions on Plasmic Science, Vol. 28, No. 2, April 2000, pp. 434-442, “Improvement of NOx Removal Efficiency Using Short-Width Pulsed Power”).

Heretofore, there has been proposed a process of successively supplying high-voltage pulses having an extremely small width for high-speed plasma processes under high, atmospheric, and low pressures (see, for example, Japanese Laid-Open Patent Publication No. 2004-220985).

### SUMMARY OF THE INVENTION

However, for carrying out a high-speed plasma process in a conventional fashion, it is necessary to supply a succession of high-voltage pulses in short periods, resulting in a large amount of supplied electric power. This leads to a high running cost, which is not advantageous.

It is an object of the present invention to provide a discharge device which is capable of achieving a reduced amount of supplied electric power, a lower cost such as a running cost, and increased output efficiency.

[1] According to the present invention, there is provided a discharge device comprising a pair of electrodes, a pulse generator for applying pulses between the pair of electrodes, and a pulse controller for controlling the pulse generator to generate electric discharges between the pair of electrodes, wherein the pulse controller comprises a first controller for applying at least one high-energy first pulse between the pair of electrodes in a first interval to promote a discharge breakdown between the pair of electrodes, and a second controller for applying at least two second pulses, which are lower in energy than the first pulse, between the pair of electrodes in a second interval after the discharge breakdown has occurred between the pair of electrodes, thereby to maintain the discharge breakdown between the pair of electrodes.
[2] Preferably, the first pulse has a peak voltage value Va and the second pulse has a peak voltage value Vb, the peak voltage value Va and the peak voltage value Vb being related to each other as follows:

Va>Vb.

[3] Preferably, the second pulse has a pulse frequency ranging from 1 to 400 kHz.
[4] Preferably, the first controller applies at least two of the first pulses between the pair of electrodes in the first interval, and the first pulse has a pulse period Ta and the second pulse has a pulse period Tb, the pulse period Ta and the pulse period Tb being related to each other as follows:

Ta≧Tb.

[5] The first pulse may be applied as a high-energy third pulse between the pair of electrodes in a third interval from a stage in which the discharge breakdown has occurred between the pair of electrodes to the second interval.
[6] Preferably, the first pulse has a peak voltage value Va, the third pulse has a peak voltage value Vc, the first pulse has a current conduction period Ti1, and the third pulse has a current conduction period Ti3, the peak voltage value Va, the peak voltage value Vc, the current conduction period Ti1, and the current conduction period Ti3 satisfying the following relationships:

Va>Vc

Ti1<Ti3.

[7] Preferably, the second pulse has a peak current value Ib, the third pulse has a peak current value Ic, the second pulse has a current conduction period Ti2, and the third pulse has a current conduction period Ti3, the peak current value Ib, the peak current value Ic, the current conduction period Ti2, and the current conduction period Ti3 satisfying the following relationships:

Ib≦Ic

Ti2<Ti3.

[8] Preferably, the second pulse has a pulse frequency ranging from 1 to 400 kHz.
[9] Preferably, at least two of the first pulses are applied in the first interval, at least two of the third pulses are applied in the third interval, and each of the first pulses has a pulse period Ta, each of the second pulses has a pulse period Tb, and each of the third pulses has a pulse period

Tc, the pulse period Ta, the pulse period Tb, and the pulse period Tc satisfying the following relationships:

Ta=Tc

Tb≦Tc.

[10] Preferably, the number of the third pulses ranges from 1 to 10.
[11] Preferably, the number of the first pulses is up to 10.
[12] The pulse generator may include a pulse generating circuit having a DC power supply and a transformer and a switch which are connected in series to each other across the DC power supply, and the pulse controller turns on the switch to store an induced energy in the transformer and turns off the switch to generate the pulses in a secondary winding of the transformer.
[13] Preferably, the second controller changes an inductance of at least a primary winding of the transformer at a starting time of the second interval.
[14] Preferably, the second controller changes a period to store the induced energy in the transformer at a starting time of the second interval.
[15] Preferably, the starting time of the second interval is a time when a preset period has elapsed from a starting time of the first interval.
[16] Alternatively, the pulse controller may comprise a discharge breakdown detector for detecting when the discharge breakdown occurs between the pair of electrodes, based on the voltage between the pair of electrodes, wherein the starting time of the second interval may be a time when a preset period has elapsed from a time at which the discharge breakdown detector detects when the discharge breakdown occurs between the pair of electrodes.
[17] In the present invention, among the pair of electrodes, one of the electrodes is a central electrode that is insulated by an insulator, and another of the electrodes is a ground electrode, the central electrode and the ground electrode are separated from each other and are in contact with a surface of the insulator, and creeping discharge is carried out via the surface of the insulator.
[18] In the present invention, among the pair of electrodes, one of the electrodes is a central electrode that is insulated by an insulator, and another of the electrodes is a ground electrode, the central electrode and the ground electrode are arranged in confronting relation to each other with a space therebetween, and spark discharge is carried out between the central electrode and the ground electrode.

The discharge device according to the present invention is capable of achieving a reduced amount of supplied electric power, a lower cost such as a running cost, and increased output efficiency.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a discharge device according to a present embodiment;

FIG. 2 is a block diagram showing a circuit arrangement of the discharge device according to the present embodiment;

FIG. 3 is a timing chart showing the manner in which a pulse generating circuit operates;

FIG. 4 is a circuit diagram illustrative of an example of a control process performed by an inductance changer;

FIG. 5 is a timing chart showing a processing sequence of the discharge device according to the present embodiment;

FIG. 6 is a block diagram showing a circuit arrangement of a discharge device according to a modification;

FIG. 7 is a structural drawing showing an example in which the discharge device according to the present embodiment is applied to an ignition device, and in particular, showing main components of an engine in which the ignition device is used;

FIG. 8 is a cross sectional view with partial omission showing an example of a creeping discharge type spark plug;

FIG. 9 is a perspective view with partial omission showing an example of a creeping discharge type spark plug;

FIG. 10 is a side view showing a spark discharge type spark plug;

FIG. 11 is a block diagram showing an example of a pulsed power supply;

FIG. 12 is a circuit diagram showing another example of a pulse generating circuit; and

FIG. 13 is a block diagram showing the configuration of an arc discharge timing circuit used in first through fourth examples, together with the discharge device according to the present embodiment.

### DESCRIPTION OF THE PREFERRED EMBODIMENTS

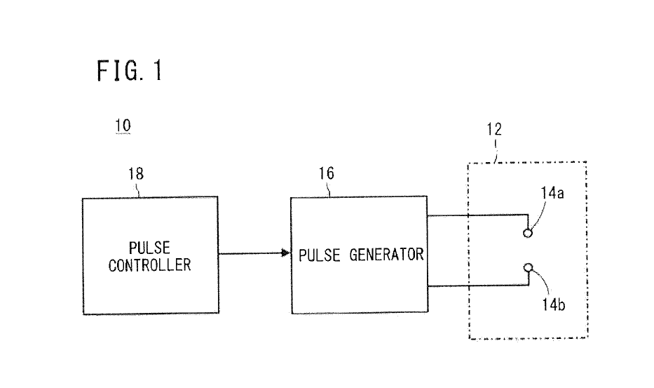

Discharge devices according to embodiments of the present invention will be described below with reference to FIGS. 1 through 13.

As shown in FIG. 1, a discharge device 10 according to an embodiment of the present invention has a pair of electrodes 14a, 14b (a cathode 14a and an anode 14b) disposed in a plasma processing chamber 12 or the like, a pulse generator 16 for applying pulses between the electrodes 14a, 14b, and a pulse controller 18 for controlling the pulse generator 16 to generate electric discharges between the electrodes 14a, 14b.

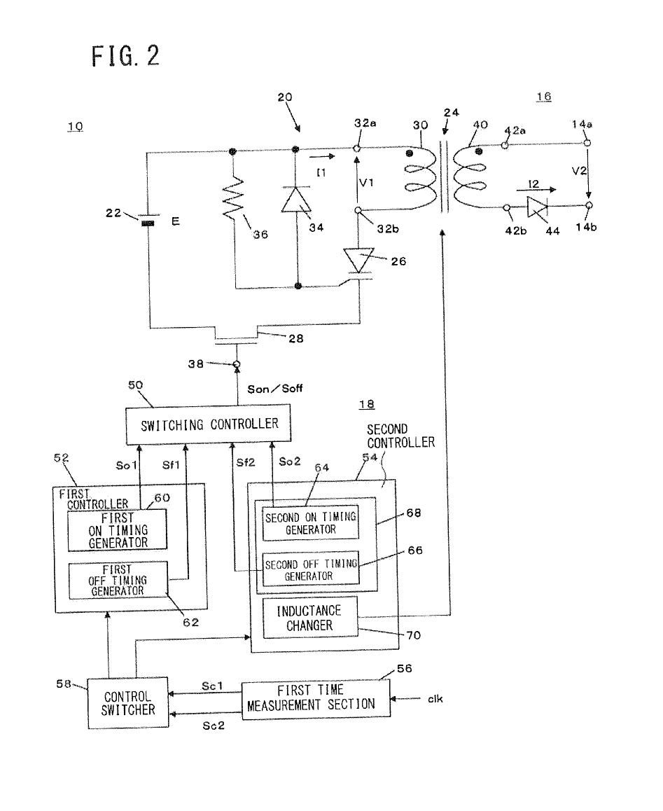

The pulse generator 16 has a pulse generating circuit 20, as shown in FIG. 2, for example. The pulse generating circuit 20 has a transformer 24, an SI thyristor 26, and a switching element 28, which are connected in series to each other across a DC power supply 22. The transformer 24 has a primary winding 30, one first terminal 32a of which is connected to the positive pole of the DC power supply 22, and another first terminal 32b of which is connected to the anode of the SI thyristor 26. A diode 34 and a resistor 36 are connected in parallel to each other between the gate of the SI thyristor 26 and the one first terminal 32a of the primary winding 30. The diode 34 has a cathode connected to the one first terminal 32a of the primary winding 30 and an anode connected to the gate of the SI thyristor 26.

The switching element 28, which comprises a MOSFET, an IGBT, or the like, for example, has a gate electrode connected to an input terminal 38, which is supplied with a control signal (an ON signal Son/an OFF signal Soff) from the pulse controller 18.

The transformer 24 has a secondary winding 40, one second terminal 42a of which is connected to the one electrode 14a (cathode), and another second terminal 42b of which is connected to the other electrode 14b (anode).

A diode 44 is connected between the other second terminal 42b of the secondary winding 40 and the other electrode 14b. The diode 44 is forward-connected in such a direction that when high-voltage pulses are generated, a current flows from the secondary winding 40 to the other second terminal 42b, and to the other electrode 14b (anode). In other words, the diode 44 has an anode connected to the other second terminal 42b and a cathode connected to the other electrode 14b.

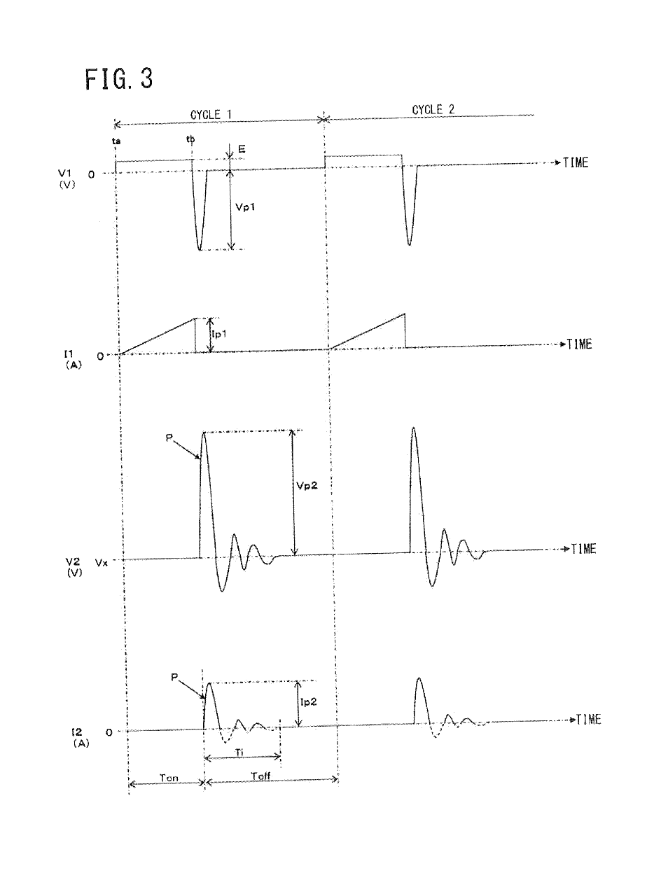

Circuit operations of the pulse generating circuit 20 will be described below with reference to FIG. 3.

When the pulse controller 18 supplies an ON control signal (ON signal Son: a high level signal, for example) to the input terminal 38 of the pulse generating circuit 20 at a starting time to of cycle 1 in FIG. 3, the switching element 28 is turned on, thereby turning on the SI thyristor 26 through a turn-on process. When the SI thyristor 26 is turned on, a voltage, which is substantially the same as the voltage E of the DC power supply 22, is applied to the transformer 24. If the transformer 24 has a primary inductance L1, then a primary current I1 flowing through the primary winding 30 of the transformer 24 linearly increases at a gradient of E/L1 over time, thereby storing an induced energy in the transformer 24.

During a period (ON period Ton) in which the SI thyristor 26 remains on, since the diode 44 connected to the secondary winding 40 blocks the flow of current, a reference voltage Vx is applied as a voltage V2 between the electrodes 14a, 14b. The reference voltage Vx is generated because the electrodes 14a, 14b and the medium therebetween are equivalent to a capacitor, and differs depending on the type of the plasma process.

Thereafter, when the primary current I1 reaches a predetermined peak value (crest value) Ip1 at time tb, the pulse controller 18 supplies an OFF control signal (OFF signal Soff: a low-level signal, for example) to the input terminal 38 of the pulse generating circuit 20. At this time, the switching element 28 is turned off, thereby turning off the SI thyristor 26 through a turn-off process, and starting supply of a high-voltage pulse P between the electrodes 14a, 14b. If the voltage of the DC power supply 22 is represented by E, the period (ON period) during which the switching element 28 remains on is represented by Ton, and the primary inductance of the transformer 24 is represented by L1, then the peak value Ip1 is expressed by:

Ip1=E×Ton/L1

When the SI thyristor 26 is turned off, a pulsed induced electromotive force Vp1 is generated in the transformer 24, thereby causing a secondary current I2 to flow quickly in the forward direction of the diode 44. At this time, a pulsed high voltage Vp2 (high-voltage pulse P) depending on the induced electromotive force Vp1 is applied between the pair of electrodes 14a, 14b.

After the peak time of the high voltage Vp2, since energy is consumed in the plasma processing chamber 12, the secondary current 12 is gradually attenuated. The secondary current 12 reaches a reference level (0 (A)) at a time before a predetermined OFF period Toff (during which the switching element 28 is turned off) elapses. Therefore, the period of time from time tb to the time when the secondary current 12 reaches the reference level serves as a current conduction period Ti.

When the OFF period Toff elapses, cycle 2 starts, repeating the same operation as cycle 1.

Next, the pulse controller 18 will be described below. The pulse controller 18 includes a switching controller 50 for supplying the ON signal Son and the OFF signal Soff to the switching element 28 of the pulse generating circuit 20, a first controller 52, a second controller 54, a first time measurement section 56, and a control switcher 58.

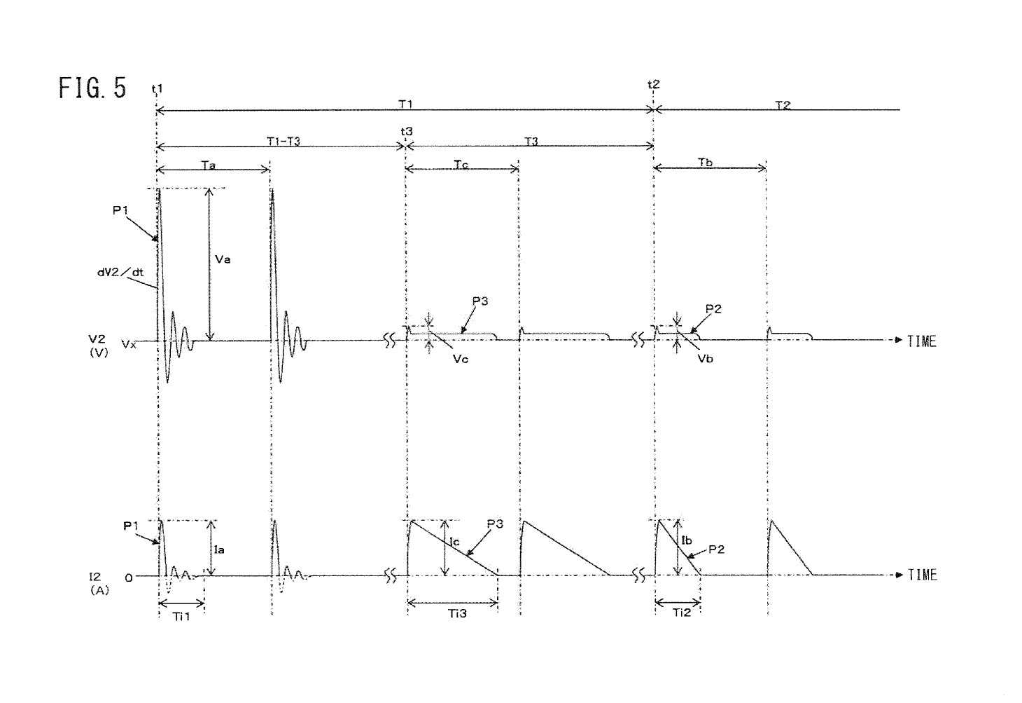

In a first interval Ti (see FIG. 5) in each cycle (which is different from cycle 1, cycle 2 in FIG. 3) of the plasma process, the first controller 52 applies at least one high-energy first pulse P1 between the electrodes 14a, 14b in order to promote a discharge breakdown between the electrodes 14a, 14b.

The first controller 52 has a first ON timing generator 60 for generating an ON timing signal So1 for turning on the switching element 28 in the first interval T1, and a first OFF timing generator 62 for generating an OFF timing signal Sf1 for turning off the switching element 28 in the first interval T1. For example, the first OFF timing generator 62 delays the ON timing signal So1 from the first ON timing generator 60 by a preset time, and outputs the delayed ON timing signal So1 as the OFF timing signal Sf1. The switching controller 50 turns on the switching element 28 based on the ON timing signal So1 from the first ON timing generator 60, and turns off the switching element 28 based on the OFF timing signal Sf1 from the first OFF timing generator 62. Therefore, the period during which the OFF timing signal Sf1 is output from the first OFF timing generator 62 serves as a pulse period Ta (=1/pulse frequency) of the first pulse P1. Although not shown, the period from the time when the ON timing signal So1 is output to the time when the OFF timing signal Sf1 is output corresponds to the period for storing an induced energy for generating the first pulse P1.

In a second interval T2 (see FIG. 5) after a discharge breakdown has occurred between the electrodes 14a, 14b in each cycle of the plasma process, the second controller 54 applies at least two second pulses P2, which are lower in energy than the first pulse P1, between the electrodes 14a, 14b in order to maintain the discharge breakdown between the electrodes 14a, 14b.

The second controller 54 has a second ON timing generator 64 for generating an ON timing signal So2 for turning on the switching element 28 in the second interval T2, and a second OFF timing generator 66 for generating an OFF timing signal Sf2 for turning off the switching element 28 in the second interval T2. For example, the second OFF timing generator 66 delays the ON timing signal So2 from the second ON timing generator 64 by a preset time, and outputs the delayed ON timing signal So2 as the OFF timing signal Sf2. The switching controller 50 turns on the switching element 28 based on the ON timing signal So2 from the second ON timing generator 64, and turns off the switching element 28 based on the OFF timing signal Sf2 from the second OFF timing generator 66. Therefore, the period during which the OFF timing signal Sf2 is output from the second OFF timing generator 66 serves as a pulse period Tb (=1/pulse frequency) of each of the second pulses P2. Although not shown, the period from the time when the ON timing signal So2 is output to the time when the OFF timing signal Sf2 is output corresponds to the period for storing an induced energy for generating each of the second pulses P2. The second ON timing generator 64 and the second OFF timing generator 66 jointly make up a storage period changer 68 for changing the period for storing an induced energy.

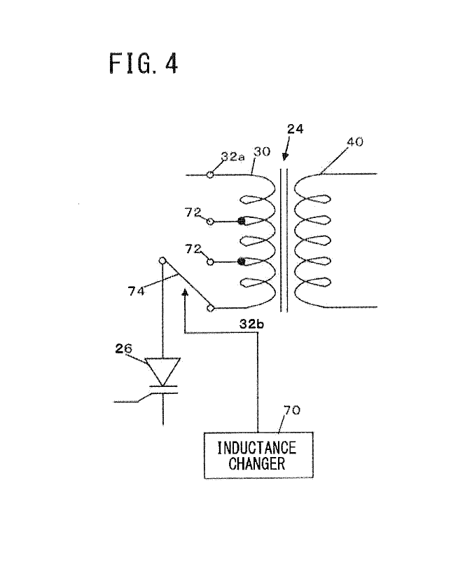

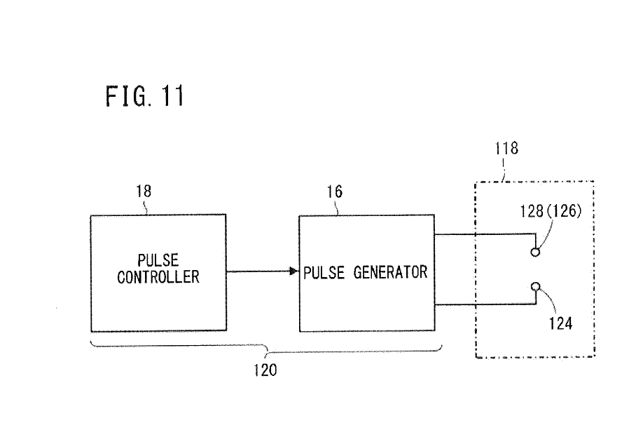

The second controller 54 also includes an inductance changer 70 for changing at least the inductance L1 of the primary winding 30 of the transformer 24 at a starting time t2 of the second interval T2. As shown in FIG. 4, the inductance L1 of the primary winding 30 should preferably be changed by connecting at least one tap terminal 72 to the primary winding 30 and selectively connecting the other first terminal 32b and the tap terminal 72 to the anode of the SI thyristor 26 with a switching device 74 such as a multiplexer or the like. Alternatively, two transformers may be used under a switching control, as disclosed in the embodiment shown in FIG. 11 and following the figures of Japanese Laid-Open Patent Publication NO. 2007-014089. The first time measurement section 56 outputs a first switching signal Sc1 at the starting time of each cycle of the plasma process (starting time t1 of the first interval T1). counts reference clock pulses clk from the starting time t1 of the first interval T1, and outputs a second switching signal Sc2 at a time (starting time t2 of the second interval T2) when a preset period has elapsed from the starting time t1 of the first interval T1.

The control switcher 58 outputs a command signal to stop the control process by the second controller 54 and to start the control process of the first controller 52, based on the first switching signal Sc1 input from the first time measurement section 56. The control switcher 58 also outputs a command signal to stop the control process by the first controller 52 and to start the control process of the second controller 54, based on the second switching signal Sc2 input from the first time measurement section 56.

A processing sequence of the discharge device 10 according to the present embodiment will be described below with reference to the timing chart shown in FIG. 5. In FIG. 5, the signal waveform on the primary winding 30 of the transformer 24 is omitted from illustration, and the voltage waveform (see the upper section of FIG. 5) and the current waveform (see the lower section of FIG. 5) on the secondary winding 40 of the transformer 24 are illustrated schematically.

As shown in FIG. 5, the first controller 52 starts to perform a control process at the starting time of each cycle of the plasma process (starting time t1 of the first interval T1), and the pulse generator 16 generates and applies a high-energy first pulse P1 between the electrodes 14a, 14b. While no arc discharge is produced between the electrodes 14a, 14b, the first pulse P1 has an impulsive voltage waveform with the voltage V2 thereof rising and falling sharply and a current waveform with the current I2 thereof rising sharply and falling somewhat sharply, although not so sharply as the voltage V2. The pulse generator 16 generates at least one first pulse P1.

When the high-energy first pulse P1 is applied between the electrodes 14a, 14b, an electric discharge occurs between the electrodes 14a, 14b. More specifically, when the period during which the first pulse P1 is applied reaches a predetermined period, a glow discharge is caused in which, when positive ions impinge upon the cathode 14a, the cathode 14aemits secondary electrons, which generate new positive ions. If the voltage V2 rises at a rate (voltage rising rate dV2/dt) in a range from about 30 to 500 kV/μs on a positive-going edge of the first pulse P1, then a plasma stream starts to grow from the anode 14b toward the cathode 14a. As the period during which the first pulse P1 is applied becomes longer, the stream grows fully into a branched stream between the anode 14b and the cathode 14a. A further increase in the period during which the first pulse P1 is applied causes local current concentrations, until finally an arc discharge (discharge breakdown) occurs between the anode 14b and the cathode 14a. An arc discharge may be caused by application of one first pulse P1, or may be developed when the first pulse P1 is applied a plurality of times.

When an arc discharge occurs, a discharge breakdown takes place between the electrodes 14a, 14b, thereby lowering the impedance between the electrodes 14a, 14b. After the discharge breakdown has occurred, the peak voltage value of the first pulse P1 is lowered. According to the principle of conservation of energy, the current flows for a long conduction period, and hence has a current waveform in which the current falls gradually over time. The first pulse P1 applied after the discharge breakdown has occurred has a different waveform from the waveform thereof at the time when no discharge breakdown takes place between the electrodes 14a, 14b. Hereinafter, the period from time t3 when the discharge breakdown occurs to a starting time t2 of the second interval T2 (third interval) will be referred to as a “discharge breakdown achieving period T3”, the period from the starting time t1 of the first interval T1 to time t3 when the discharge breakdown occurs will be referred to as a “discharge breakdown preparing period T1-T3”, and the pulse that is output in the discharge breakdown achieving period T3 will be referred to as a “third pulse P3”. The second interval T2 may also be referred to as a “discharge breakdown maintaining period”.

After the discharge breakdown has taken place between the electrodes 14a, 14b, the second controller 54 starts to perform a control process from the starting time t2 of the second interval T2.

When the control process of the second controller 54 is started, a low-energy second pulse P2 is generated in a pulse period (=1/pulse frequency), which is different from or the same as the first pulse P1, and the second pulse P2 is applied between the electrodes 14a, 14b. The second pulse P2 is applied in order to maintain the discharge breakdown that has occurred between the electrodes 14a, 14b with a low energy. More specifically, the second pulse P2 has a current I2 that flows in a shorter conduction period and hence falls with a greater gradient. The conduction period of the current I2 is realized by shortening the period from the time when the ON timing signal So2 is output from the second ON timing generator 64 of the second controller 54 to the time when the OFF timing signal Sf2 is output from the second OFF timing generator 66, i.e., the period for storing an induced energy for generating the second pulse P2. The gradient of the current waveform of the current I2 is realized by changing (i.e., reducing) the inductance L1 of the primary winding 30 with the inductance changer 70 of the second controller 54. The pulse frequency of the second pulse P2 is realized by establishing the output frequency of the ON timing signal So2 after the conduction period of the current I2 is established.

The conduction period of the current I2, the falling gradient of the current I2, and the pulse frequency of the second pulse P2 should preferably be established by the second controller 54 by conducting experiments, simulations, etc., based on the types of plasma processes, reactive species, etc., determining optimum ranges based on the experiments, the simulations, etc., and selecting appropriate values from the optimum ranges based on the type of plasma process, the reactive species, etc., which are actually employed.

More specifically, if the first pulse P1 has a peak voltage value Va and the second pulse P2 has a peak voltage value Vb, then the peak voltage values Va, Vb are related to each other as follows:

Va>Vb

The peak voltage values Va, Vb should preferably satisfy the inequality (1/3000)×Va<Vb<Va, more preferably, should satisfy the inequality (1/1000)×Va<Vb<(3/4)×Va, and particularly preferably, should satisfy the inequality (1/600)×Va<Vb<(1/2)×Va. In principle, since the peak current value Ia of the first pulse P1 and the peak current value Ib of the second pulse P2 are essentially the same, if the peak voltage values Va, Vb are set to the above range, then the electric power supplied per unit time in the second interval T2 during which the second pulse P2 is output is smaller than the electric power supplied per unit time in the first interval T1 during which the first pulse P1 is output.

If the pulse period of the first pulse P1 is represented by Ta and the pulse period of the second pulse P2 is represented by Tb, then the pulse periods Ta, Tb are related to each other as follows:

Ta≧Tb

The pulse frequency of the second pulse P2 (=1/pulse period Tb) should preferably be in the range from 1 to 400 kHz, more preferably, should be in the range from 10 to 400 kHz, and particularly preferably, should be in the range from 200 to 300 kHz. If the pulse frequency of the second pulse P2 is too low, then the discharge breakdown that has occurred between the electrodes 14a, 14b cannot be maintained. If the pulse frequency of the second pulse P2 is too high, then the electric power supplied per unit time becomes too large and may not possibly be reduced sufficiently.

The peak voltage value Va of the first pulse P1, the peak voltage value Vc of the third pulse P3, the conduction period Ti1 of the current I2 of the first pulse P1, and the conduction period Ti3 of the current I2 of the third pulse P3 should preferably satisfy the following relationships:

Va>Vc

Ti1<Ti3

If the peak current value of the first pulse P1 is represented by Ia and the peak current value of the third pulse P3 is represented by Ic, then the peak current values Ia, Ic essentially are the same.

The peak current value Ib of the second pulse P2, the peak current value Ic of the third pulse P3, the conduction period Ti2 of the current I2 of the second pulse P2, and the conduction period Ti3 of the current I2 of the third pulse P3 should preferably satisfy the following relationships:

Ib≦Ic

Ti2<Ti3

At this time, the electric power supplied per unit time in the second interval T2 during which the second pulse P2 is output is smaller than the electric power supplied per unit time in the discharge breakdown achieving period Tlb during which the third pulse P3 is output. An upper limit for the peak current value Ib of the second pulse P2 should preferably be (5/6)×Ic, more preferably, should be (2/3)×Ic, and particularly preferably, should be (1/2)×Ic. The conduction periods Ti2, Ti3 should preferably satisfy the inequality (1/100)×Ti3<Ti2<(5/6)×Ti3, more preferably, should satisfy the inequality (1/50)×Ti3<Ti2<(2/3)×Ti3, and particularly preferably, should satisfy the inequality (1/20)×Ti3<Ti2<(1/2)×Ti3.

The pulse period Ta of the first pulse P1, the pulse period Tb of the second pulse P2, and the pulse period Tc of the third pulse P3 should preferably satisfy the following relationships:

Ta=Tc

Tb≦Tc

As described above, the pulse frequency of the second pulse P2 (=1/pulse period Tb) should preferably be in the range from 1 to 400 kHz, more preferably, should be in the range from 10 to 400 kHz, and particularly preferably, should be in the range from 200 to 300 kHz.

The number of first pulses P1 should preferably be up to 10. If the number of first pulses P1 is too large, then the high-energy period is increased, thus possibly failing to reduce electric power sufficiently. The number of first pulses P1 could be nil. More specifically, if an arc discharge is produced during the time that the first pulse P1 is applied for the first time, since the pulse occurs during the discharge breakdown achieving period T3, the pulse will be applied as the third pulse P3 between the electrodes 14a, 14b.

The number of third pulses P3 should preferably be in the range from 1 to 10. Since a third pulse P3 is essentially a high-energy first pulse P1, if the number of third pulses P3 is too large, then the high-energy period is increased, thus possibly failing to reduce electric power sufficiently.

The number of first pulses P1 and the number of third pulses P3 are determined by the pulse period Ta of the first pulse P1 and the period that is set in the first time measurement section 56 (the period from the starting time t1 of the first interval T1 to the starting time t2 of the second interval T2).

The difference between output efficiencies of a comparative example and a later described inventive example will be described below.

According to the comparative example, in the interval T2 after a discharge breakdown has occurred between the electrodes 14a, 14b, third pulses P3 are successively supplied to the electrodes 14a, 14b in order to maintain the discharge breakdown. According to the inventive example, in the interval T2 after a discharge breakdown has occurred between the electrodes 14a, 14b, second pulses P2 are successively supplied to the electrodes 14a, 14b in order to maintain the discharge breakdown.

The third pulse P3 and the second pulse P2 have different parameters, as follows. If the third pulse P3 has a pulse frequency F3, a peak voltage value Vc, a peak current value Ic, and a current conduction period Ti3, and the second pulse P2 has a pulse frequency F2, a peak voltage value Vb, a peak current value Ib, and a current conduction period Ti2, then such quantities are related as follows:

F3=200 kHz

F2=200 kHz

Vc=Vb

Ic=Ib

Ti2=Ti3/10

In this case, since the current conduction period in the inventive example may be 1/10 of the current conduction period in the comparative example, the electric power supplied per unit time, i.e., the electric power supplied to the electrodes 14a, 14b per unit time according to the inventive example can be reduced to 1/10 of the electric power supplied according to the comparative example.

More specifically, if it is assumed that the output electric power capable of maintaining a discharge breakdown is represented by Px and the electric power supplied according to the comparative example is represented by Py, then the output efficiency according to the comparative example is represented by Px/Py. Since the electric power supplied according to the inventive example is represented by Py/10, the output efficiency according to the inventive example is represented by 10Px/Py and hence is higher than the output efficiency according to the comparative example. According to the inventive example, if the peak voltage value Vb, the peak current value Ib, the pulse frequency F2, and the current conduction period Ti2 of the second pulse P2 are selected in the above preferred ranges, then the degree to which the electric power supplied per unit time is reduced can be changed differently.

As described above, the discharge device 10 according to the present embodiment includes the first controller 52 for applying at least one high-energy first pulse P1 between the electrodes 14a, 14b in the first interval Ti in order to promote a discharge breakdown between the electrodes 14a, 14b, and the second controller 54 for applying at least two second pulses P2, which are lower in energy than the first pulse P1, in the second interval T2 after the discharge breakdown has occurred between the electrodes 14a, 14b, to thereby maintain the discharge breakdown between the electrodes 14a, 14b. Therefore, the discharge device 10 according to the present embodiment is capable of achieving a reduced amount of supplied electric power, a lower cost such as a running cost, and increased output efficiency.

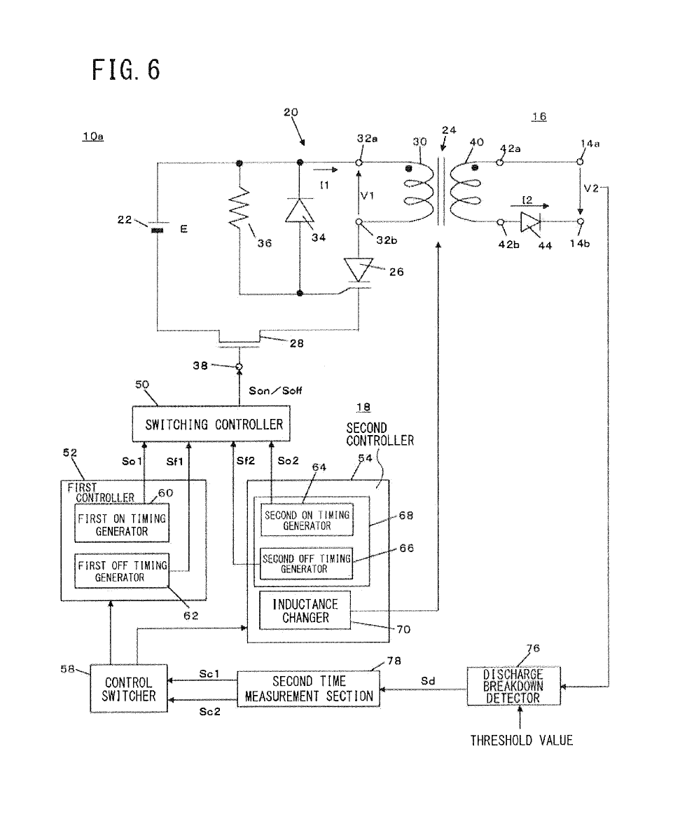

A discharge device 10a according to a modification will be described below with reference to FIG. 6. The discharge device 10a according to the modification is of essentially the same arrangement as the discharge device 10 according to the above embodiment, but differs therefrom in the following manner.

The pulse controller 18 further includes a discharge breakdown detector 76, and also has a second time measurement section 78 instead of the first time measurement section 56 shown in FIG. 2.

The discharge breakdown detector 76 detects when a discharge breakdown occurs between the electrodes 14a, 14b based on the voltage between the electrodes 14a, 14b. More specifically, the discharge breakdown detector 76 outputs a detection signal Sd when the voltage between the electrodes 14a, 14b is equal to or lower than a preset threshold voltage. The threshold voltage is determined in the following manner. High-voltage pulses are applied between the electrodes 14a, 14b, and a voltage between the electrodes 14a, 14b at the time a discharge breakdown occurs therebetween is measured. Such a process is carried out a plurality of times, and measured voltages are averaged to calculate an average value. A voltage which is in the range from 1/100 to 1/10 of the average value is added to the average value, and the sum is used as the threshold voltage. The voltage which is to be added to the average value may be selected in the range from 1/100 to 1/10 of the value, depending on the type of the plasma process to be carried out.

The second time measurement section 78 outputs a first switching signal Sc1 at the starting time of each cycle of the plasma process (starting time t1 of the first interval T1), and based on the detection signal Sd input from the discharge breakdown detector 76, outputs a second switching signal Sc2 at a time when a preset period (which may include ni1, unlike the preset period in the first time measurement section 56) has elapsed from the time at which the detection signal Sd is input from the discharge breakdown detector 76.

The modification offers the same advantages as the discharge device 10 according to the above embodiment, and in addition is highly reliable because the control process can be switched to the control process by the second controller 54 only after a discharge breakdown actually is developed.

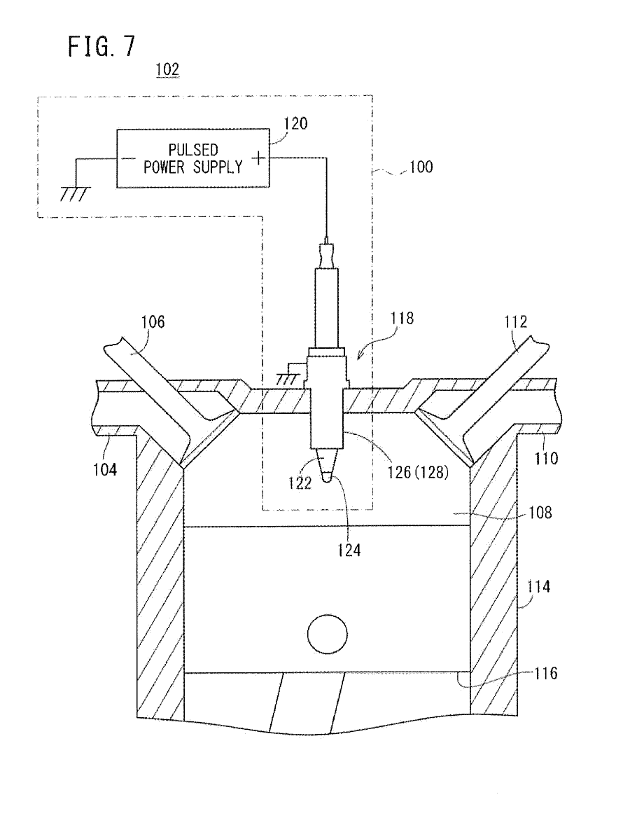

Next, with reference to FIGS. 7 through 11, an example shall be described in which the aforementioned discharge device 10 is applied to an ignition device 100.

First, principle components of an engine 102, in which the ignition device 100 according to the present embodiment is used, will be described with reference to FIG. 7.

As shown in FIG. 7, the engine 102 includes an intake pipe 104, an intake valve 106, a combustion chamber 108, an exhaust pipe 110, an exhaust valve 112, a cylinder 114, a piston 116, and the ignition device 100 according to the present embodiment. The ignition device 100 includes a spark plug 118 and a pulsed power supply 120.

The spark plug 118 includes an insulator (insulating body) 122, a central electrode 124 that is insulated from ground potential by the insulator 122, and a main metal fitting 126. Creeping discharge is carried out via the surface of the insulator 122. The main metal fitting 126 functions as a ground electrode 128.

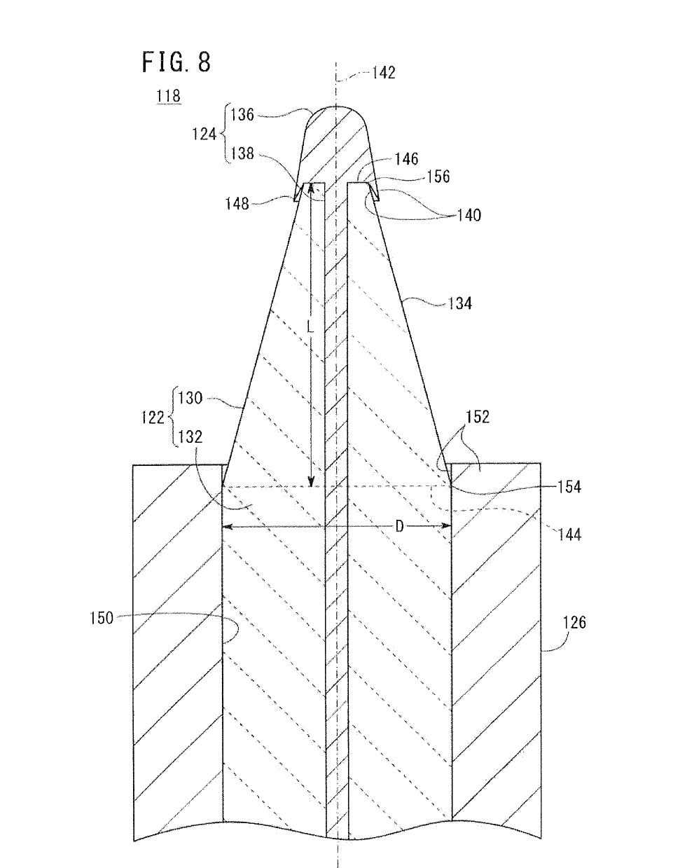

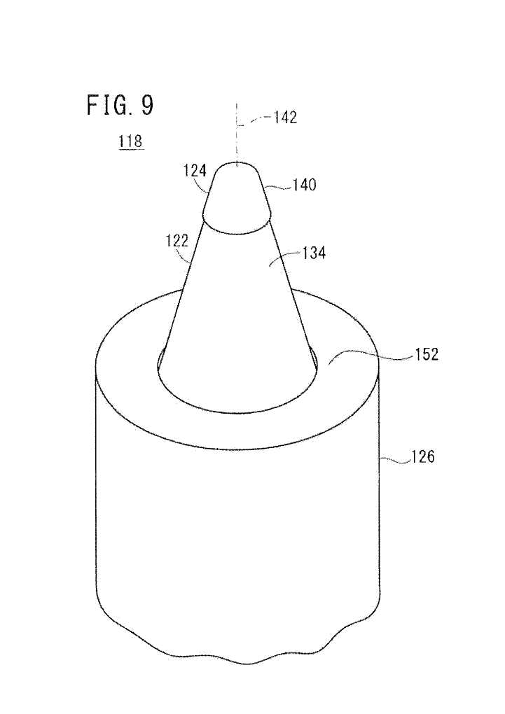

As shown in FIGS. 8 and 9, the insulator 122 comprises, for example, a frustoconical protruding structural member 130, and a cylindrical insulating structural member 132 (i.e., a structural member for electrically insulating the central electrode 124 and the main metal fitting 126). The surface of the protruding structural member 130 constitutes an exposed insulator surface 134.

The central electrode 124 comprises a cap 136 disposed on a distal end, and a rod-shaped body 138 that penetrates from the cap 136 and through the insulator 122. Surfaces of the cap 136, and in particular a side surface and a surface thereof that confronts the protruding structural member 130 of the insulator 122, constitute a first exposed conductor surface 140, which makes up a starting point or an ending point of the creeping discharge.

Owing to the insulator 122, the central electrode 124 is electrically insulated from the main metal fitting 126, and the central electrode 124 is fixed mechanically along a center axis 142 of the main metal fitting 126.

The rod-shaped body 138 has a circular rod shape, for example. The rod-shaped body 138 is embedded in the insulator 122 and extends in the direction of the center axis 142 thereof. The rod-shaped body 138 is embedded in the interior over an interval that extends at least from a base 144 (as shown by the dotted line in FIG. 8) of the protruding structural member 130 to a distal end 146. Consequently, the main metal fitting 126 and the rod-shaped body 138 are separated by the protruding structural member 130, and act to generate a dielectric barrier discharge in a space where a discharge path of the creeping discharge exists. The rod-shaped body 138 also reaches to the interior of the insulating structural member 132.

In particular, the protruding structural member 130 of the aforementioned insulator 122 has a tapered shape such that the diameter of the protruding structural member 130 narrows from the base 144 to the distal end 146 thereof. As a result, at the side of the distal end 146, the insulator that covers the rod-shaped body 138 becomes thinner, thereby promoting the dielectric barrier discharge and facilitating generation of a creeping discharge. Further, on the side of the base 144 proximate the opening of the main metal fitting 126, the insulator that covers the rod-shaped body 138 thickens, thereby facilitating insulation of the rod-shaped body 138.

The cap 136 is exposed to the exterior of the insulator 122 and is disposed on the distal end 146 of the protruding structural member 130. The distal end side of the cap 136 is rounded. Owing thereto, abrasion and wear of the distal end side of the cap 136 are suppressed. A flange (peak) 148 is provided, which extends along the exposed insulator surface 134 of the protruding structural member 130 from the base of the cap 136. Owing thereto, an accommodating space is formed, which flares out at the base portion of the cap 136. The distal end 146 of the protruding structural member 130 is accommodated in the space, whereby the cap 136 is fixed to the protruding structural member 130.

The main metal fitting 126 has a cylindrical shape, for example, and includes a hollow portion 150 therein in which the insulating structural member 132 of the insulator 122 is accommodated. The surface of the main metal fitting 126, and in particular, the distal end surface thereof and the surface that confronts the protruding structural member 130 of the insulator 122, constitutes a second exposed conductor surface 152, which makes up a starting point or an ending point of the creeping discharge.

The utility of the spark plug 118 to produce a plasma that expands significantly will not be completely lost, even if the diameter of the protruding structural member 130 is constant, or if the protruding structural member 130 has a fat tip (reverse tapered) shape, in which the diameter widens or expands from the base 144 of the protruding structural member 130 toward the distal end 146 thereof.

As a result of the insulating structural member 132 being fixed inside the hollow portion 150 of the main metal fitting 126, the insulator 122 is fixed in place with respect to the main metal fitting 126. The protruding structural member 130 is retained in a condition of projecting from the opening of the main metal fitting 126. Further, the protruding structural member 130 and the insulating structural member 132 need not be joined together integrally, but may be constituted by separate members, respectively.

As for the insulating material that makes up the insulator 122, there may be adopted a ceramic material such as alumina, zirconia, or the like, or resin such as vinyl chloride resin, fluororesin, or the like, may also be adopted. For the material of the insulator 122, preferably, an insulator is selected having a dielectric constant of ten or greater, thereby promoting the dielectric barrier discharge and facilitating generation of the creeping discharge.

As for the conductor that constitutes the main metal fitting 126 and the central electrode 124, there may be adopted a metal such as platinum or the like, or stainless steel, or an alloy such as a nickel alloy or the like may also be adopted. A conductive ceramic may also be used.

In addition, as shown in FIG. 7, the distal end part of the spark plug 118 is exposed and arranged in the interior of the combustion chamber 108. In FIG. 7, an example is shown in which the spark plug 118 is positioned substantially on the same axis as the piston 116 inside the combustion chamber 108.

The pulsed power supply 120 applies plural voltage pulses between the central electrode 124 and the main metal fitting 126 (ground electrode 128) of the spark plug 118 to thereby generate a discharge. The negative electrode of the pulsed power supply 120 and the electrode 128 of the spark plug 118 are grounded respectively, whereas the positive electrode of the pulsed power supply 120 and the central electrode 124 of the spark plug 118 are connected together electrically through a cable or the like. It is a matter of course that the connections between the positive and negative electrodes of the pulsed power supply 120, and the central electrode 124 and ground electrode 128 of the spark plug 118 may be combined in an opposite manner to that described above.

Briefly describing the operations of the engine 102, at first, the intake valve 106 is opened, and by the piston 116 moving in a direction away from the combustion chamber 108, fuel (an air-fuel mixture) is drawn into the combustion chamber 108. At this time, accompanying introduction of the air-fuel mixture, flowing of the air-fuel mixture (gas flow) occurs in the combustion chamber 108. Thereafter, the intake valve 106 closes at a stage at which the piston 116 has moved to a bottom dead center position. Even in this state, flowing of the gas occurs due to inertia. Then, by the piston 116 moving in a direction toward the combustion chamber 108, the pressure inside the combustion chamber 108 increases. In this state as well, flowing of the gas occurs due to inertia. At this time, a pulsed voltage, which is generated in the pulsed power supply 120, is applied between the central electrode 124 and the ground electrode 128 of the spark plug 118. When the pulsed voltage is applied between the central electrode 124 and the ground electrode 128 of the spark plug 118, a creeping discharge (arc discharge) is generated and takes place along the exposed insulator surface 134 of the protruding structural member 130.

As a result of the creeping discharge, a plasma is generated. A flame is induced simultaneously with or following generation of the plasma, whereupon ignition of the air-fuel mixture is carried out inside the combustion chamber 108. In accordance with the arc discharge, the flame progresses and expands along the flow (gas flow) of the air-gas mixture. Upon combustion of the air-gas mixture, although not illustrated, a generated exhaust gas is discharged to the exterior through the exhaust valve 112 and the exhaust pipe 110, together with an air-fuel mixture being introduced again into the combustion chamber 108.

Compared to ignition by way of discharge techniques other than creeping discharge, ignition by way of creeping discharge enables the discharge starting voltage to be reduced. Owing thereto, the insulator that covers the central electrode 124 can be thin, and the diameter of the spark plug can be narrow. Further, carbonization (carbon deposits) on the insulator 122 (i.e., adhering of carbon on the surface of the insulator 122 due to combustion of the air-fuel mixture) can be burned off by means of the creeping discharge. Consequently, misfiring due to carbon deposits can be prevented.

The protruding structural member 130 extends along the center axis 142 from the base 144 toward the distal end 146. The center axis 142 of the central electrode 124 extends in a straight line, or may be slightly curved.

In the case that the spark plug 118 is installed in the combustion chamber 108, the exposed insulator surface 134 of the protruding structural member 130, the second exposed conductor surface 152 of the main metal fitting 126, and the first exposed conductor surface 140 of the cap 136 are exposed in the combustion chamber 108 as an outside space. As a result, upon generation of a creeping discharge along the exposed insulator surface 134 of the protruding structural member 130, by means of the creeping discharge, a plasma is generated in the combustion chamber 108, whereupon ignition of the air-fuel mixture that fills the combustion chamber 108 is carried out.

The exposed insulator surface 134 of the protruding structural member 130 is connected from a boundary 154 on the side of the base 144 to a boundary 156 on the side of the distal end 146. As a result, a creeping discharge path is formed along the exposed insulator surface 134 of the protruding structural member 130 that joins the boundary 154 on the side of the base 144 and the boundary 156 on the side of the distal end 146. Also, the discharge starting voltage of the creeping discharge is low. Accordingly, in the event that such a creeping discharge path is formed, the discharge distance is long, while the discharge starting voltage is low. Further, in the case that the discharge distance is long, the plasma expands significantly. Consequently, even under conditions in which combustion is difficult, such as, for example, when lean burning is being performed, the air-fuel mixture can be ignited in a stable manner.

The exposed insulator surface 134 of the protruding structural member 130 and the second exposed conductor surface 152 of the main metal fitting 126 are in contact at the boundary 154 on the side of the base 144, and are connected while sandwiching therebetween the circumferential boundary 154 on the side of the base 144. Owing thereto, a discharge, for which the second exposed conductor surface 152 of the main metal fitting 126 forms a starting point or an ending point, progresses along the exposed insulator surface 134 of the protruding structural member 130.

The exposed insulator surface 134 of the protruding structural member 130 and the first exposed conductor surface 140 of the cap 136 are in contact at the boundary 156 on the side of the distal end 146, and are connected while sandwiching therebetween the circumferential boundary 156 on the side of the distal end 146. Owing thereto, a discharge, for which the first exposed conductor surface 140 of the cap 136 forms a starting point or an ending point, progresses along the exposed insulator surface 134 of the protruding structural member 130.

The boundary 154 on the side of the base 144 and the boundary 156 on the side of the distal end 146 are separated from each other in the direction of the center axis 142. Further, the maximum diameter D of the protruding structural member 130, preferably, is smaller than the minimum distance L in the direction of the center axis 142 from the boundary 154 on the side of the base 144 to the boundary 156 on the side of the distal end 146. As a result, the diameter of the spark plug 118 is made small, and the volume occupied by the spark plug 118 is reduced. However, even in the event that the maximum diameter D is not smaller than the minimum distance L, the utility of the spark plug 118 to produce a plasma that expands significantly will not be completely lost. The maximum diameter D of the protruding structural member 130 represents a maximum value of the dimension of the protruding structural member 130 in a radial direction perpendicular to the center axis 142. Reducing of the maximum diameter D of the protruding structural member 130 causes the insulative properties of (i.e., the ability to insulate) the central electrode 124 to be lowered slightly. However, in the spark plug 118, since by utilizing a creeping discharge the discharge starting voltage is lowered, significant problems do not occur even if the insulative properties of the central electrode 124 are slightly decreased.

Reducing the volume occupied by the spark plug 118 makes it easy to attach two or more spark plugs 118 in the combustion chamber 108, thereby facilitating multi-point ignition of the air-fuel mixture. In accordance with such multi-point ignition, even under conditions in which combustion is difficult such as, for example, when lean burning is being performed, the air-fuel mixture can be ignited in a stable manner.

As the spark plug 118, instead of the above-described creeping discharge type of spark plug, a spark discharge type of spark plug 118a may be used.

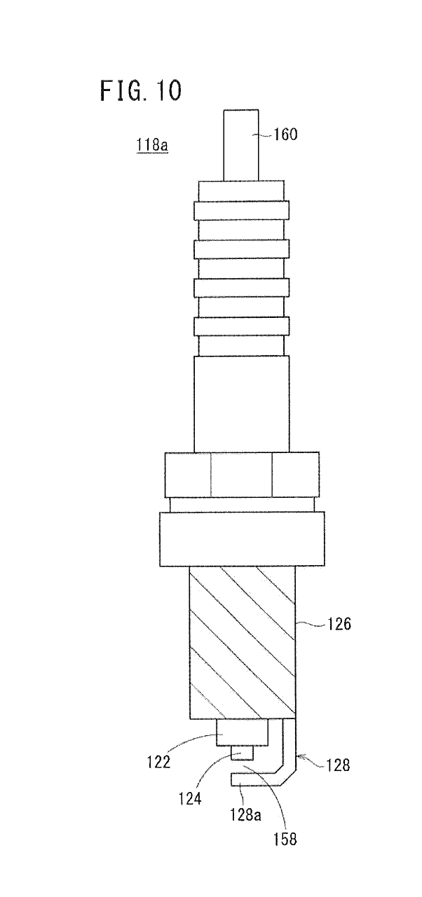

As shown in FIG. 10, the spark discharge type of spark plug 118a includes a generally rod-shaped central electrode 124, to which high voltage pulses are applied and which is insulated from ground potential by an insulator 122, a ground electrode 128, which is positioned via a discharge gap 158 (space) that extends generally above the central electrode 124, and a main metal fitting 126 to which the ground electrode 128 is connected. More specifically, the spark plug 118a includes the rod-shaped central electrode 124, the cylindrical insulator 122 that covers the central electrode 124, the cylindrical main metal fitting 126 that retains the insulator 122, the ground electrode 128 that is attached to the main metal fitting 126, and a terminal 160, which is connected electrically to a rear end part of the central electrode 124. The ground electrode 128, which is connected to the main metal fitting 126, is bent from a midpoint location thereof, and a distal end 128a thereof extends in confronting relation to a distal end of the central electrode 124.

In this case, when a pulsed voltage is applied between the central electrode 124 and the ground electrode 128 of the spark plug 118a, a spark discharge (arc discharge) is generated between the central electrode 124 and the ground electrode 128, and a plasma is created by means of the arc discharge. A flame is induced simultaneously with or following generation of the plasma, whereupon ignition of the air-fuel mixture is carried out inside the combustion chamber 108, and in accordance with the arc discharge, the flame progresses and expands along the flow (gas flow) of the air-gas mixture.

In addition, as shown in FIG. 11, the pulsed power supply 120 of an ignition device 100 according to an embodiment of the present invention includes the aforementioned pulse generator 16 for applying pulsed voltage between the central electrode 124 and the ground electrode 128, and the aforementioned pulse controller 18 for controlling the pulse generator 16 to generate electric discharges between the central electrode 124 and the ground electrode 128. Since the pulse generator 16 and the pulse controller 18 have already been discussed in detail above, duplicate explanations thereof are omitted.

Since the ignition device 100 applies the principles of the discharge device 10 according to the present embodiment, the supplied power can be reduced, together with enabling lowering of costs such as running costs, while also increasing output efficiency.

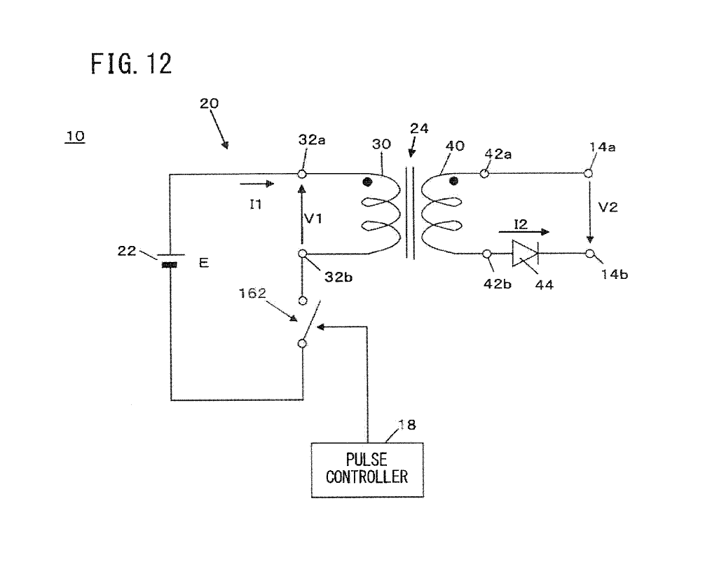

Further, in the above example, although a structure has been described in which the pulse generating circuit 20 has the transformer 24, the SI thyristor 26, and the switching element 28, which are connected in series to each other across a DC power supply 22, the present invention is not necessarily limited to such features. As shown in FIG. 12, a structure may be provided in which the pulse generating circuit 20 includes the DC power supply 22, and the transformer 24 and a single switch 162, which are connected in series to both terminals of the DC power supply 22. In addition, ON/OFF control of the switch 162 may be carried out based on a control signal from the pulse controller 18.

### FIRST EXEMPLARY EMBODIMENT

Concerning a comparative example, and examples 1 through 19, a relationship between a peak voltage value Va of the first pulse P1 and a peak voltage value Vb of the second pulse P2 was changed, and the arc discharge duration and the supplied power per one pulse at the time of arc discharge were evaluated.

### Example 1

The frequencies of the first pulse P1 and the second pulse P2 were both set at 200 kHz, and the relationship between the peak voltage value Va of the first pulse P1 and the peak voltage value Vb of the second pulse P2 was set at Vb=(1/3500)Va.

### Examples 2 through 19

Examples 2 through 19 are the same as Example 1, apart from the relationships between the peak voltage value Va of the first pulse P1 and the peak voltage value Vb of the second pulse P2 being as shown in Table 1 below.

### Comparative Example

The comparative example is the same as Example 1, apart from the relationships between the peak voltage value Va of the first pulse P1 and the peak voltage value Vb of the second pulse P2 being Vb=Va.

### <Circuit Used for Evaluation>

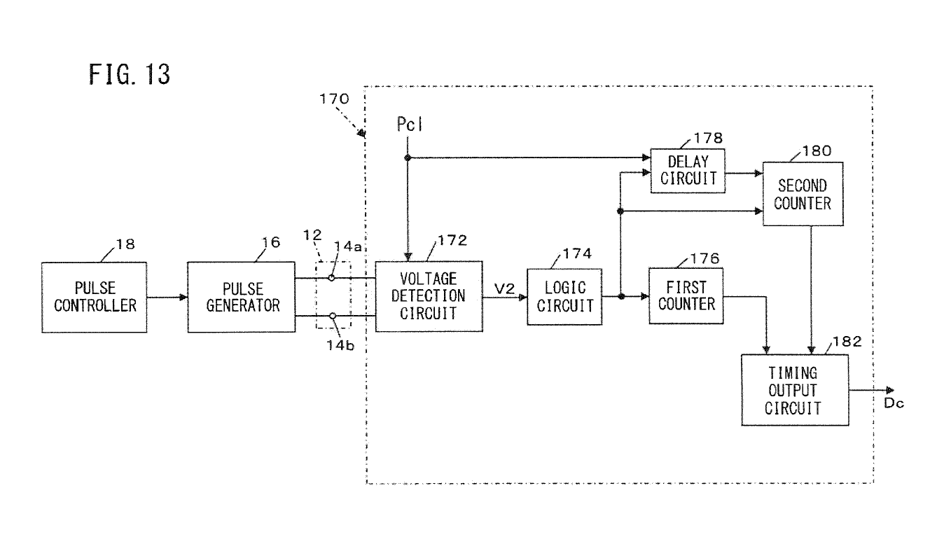

As shown in FIG. 13, an arc discharge timing circuit 170, which detects a voltage V2 between the pair of electrodes 14a and 14b and counts a time of the arc discharge duration, is connected to the pair of electrodes 14a and 14b. The arc discharge timing circuit 170 includes a voltage detection circuit 172 for detecting the voltage V2 between the pair of electrodes 14a and 14b at a point in time, for example, when a clock pulse Pct having a fixed pulse frequency rises, a logic circuit 174, which outputs a logical value of “1” if the detected voltage V2 is equal to or less than a threshold value voltage Vth, and outputs a logical value of “0” if the detected voltage V2 exceeds the threshold value voltage Vth, a first counter 176, which updates a counter value by +1 if the output from the logic circuit 174 is “1”, a second counter 180, which updates a count value by +1 if the output from the logic circuit 174 is “0” and the previous output (the output from a delay circuit 178) is “0”, and a timing output circuit 182, which outputs a counter value Dc of the first counter 176 at a point in time that the counter value of the second counter is a predetermined value (“5” in the present exemplary embodiment), and then resets to “0” the respective count values of the first counter 176 and the second counter 180. The arc discharge duration can be determined by multiplying the clock pulse Pc1 by the counter value Dc output from the timing output circuit 182.

The reason for setting the predetermined value is for the purpose of absorbing detection errors of the voltage V2. Irrespective of whether the arc discharge is maintained, cases occur in which the voltage value V2 momentarily exceeds the threshold value voltage Vth due to detection errors of the voltage V2. Thus, for avoiding such a situation, the predetermined value is provided, and cases in which the voltage V2 momentarily exceeds the threshold value voltage Vth within a short time period regulated by the predetermined value are regarded as errors and ignored. Further, in the present exemplary embodiment, the pulse frequency of the clock pulse Pct was set at 1 MHz (pulse period=1 μsec).

Further, the threshold value voltage Vth is set by performing measurement operations beforehand ten times in the voltage detecting circuit 172, to thereby measure the voltage V2 between the pair of electrodes 14a and 14b when high voltage pulses are applied between the pair of electrodes 14a and 14b for generating the arc discharge, and then taking the average value of the ten measured voltages V2, and further adding to the average value a voltage equal to 1/50 of the average value.

### <Evaluation Method>

At a time when the relationship between the peak voltage value Va of the first pulse P1 and the peak voltage value Vb of the second pulse P2 was Vb=(1/2900)Va, the arc discharge duration is given by ta, and the supplied power is given by Pa. Based thereon, the arc discharge duration and the supplied power of the Comparative Example and Examples 1 through 19 were evaluated in relation to each other. More specifically, the following evaluation criteria were followed.

### (Duration Evaluation Criteria)

Evaluation A: Duration was 100×ta or greater.

Evaluation B: Duration was 10×ta or greater, and less than 100×ta.

Evaluation C: Duration was 1×ta or greater, and less than 10×ta.

Evaluation D: Duration was 0.1×ta or greater, and less than 1×ta.

Evaluation E Duration was 0.01×ta or greater, and less than 0.1×ta.

### (Supplied Power Evaluation Criteria)

Evaluation A: Supplied power was less than 1.5×Pa.

Evaluation B: Supplied power was 1.5×Pa or greater, and less than 3.0×Pa.

Evaluation C: Supplied power was 3.0×Pa or greater, and less than 5.0×Pa.

Evaluation D: Supplied power was 5.0×Pa or greater, and less than 8.0×Pa.

Evaluation E: Supplied power was 8.0×Pa or greater.

The evaluation results are shown in Table 1.

TABLE 1

Evaluation

| | | Arc Discharge | Supplied |
|---|---|---|---|
| | Vb/Va | Duration | Power |
| Example 1 | 1/3500 | E | A |
| Example 2 | 1/3000 | D | A |
| Example 3 | 1/2990 | D | A |
| Example 4 | 1/1500 | D | A |
| Example 5 | 1/1000 | C | A |
| Example 6 | 1/990 | C | A |
| Example 7 | 1/650 | C | A |
| Example 8 | 1/600 | B | A |
| Example 9 | 1/590 | B | A |
| Example 10 | 1/100 | B | B |
| Example 11 | 1/50 | B | B |
| Example 12 | 1/10 | B | B |
| Example 13 | 1/5 | B | B |
| Example 14 | 1/4 | B | B |
| Example 15 | 3/8 | B | B |
| Example 16 | 1/2 | B | B |
| Example 17 | 5/8 | A | C |
| Example 18 | 3/4 | A | C |
| Example 19 | 7/8 | A | D |
| Comparative Example | 1 | A | E |

As understood from Table 1, in relation to arc discharge duration, an evaluation of A for Examples 17 through 19 and the Comparative Example was revealed when Vb/Va resided in a range from (5/8) to (7/8) and (1), an evaluation of B for Examples 8 through 16 was revealed when Vb/Va resided in a range from (1/600) to (1/2), an evaluation of C for Examples 5 to 7 was revealed when Vb/Va resided in a range from (1/1000) to (1/650), an evaluation of D for Examples 2 to 4 was revealed when Vb/Va resided in a range from (1/3000) to (1/1500), and an evaluation of E for Example 1 was revealed when Vb/Va was (1/3500).

In relation to supplied power, an evaluation of A for Examples 1 through 9 was revealed when Vb/Va resided in a range from (1/3500) to (1/590), an evaluation of B for Examples 10 through 16 was revealed when Vb/Va resided in a range from (1/100) to (1/2), and an evaluation of C for Examples 17 and 18 was revealed when Vb/Va was (5/8) and (3/4), and an evaluation of D for Example 19 was revealed when Vb/Va was (7/8). An evaluation of E was revealed for the Comparative Example.

When the evaluation results are considered comprehensively, it is understood that, preferably, the inequality (1/3000)×Va<Vb<Va should be satisfied, more preferably, the inequality (1/1000)×Va<Va<(3/4)×Va should be satisfied, and particularly preferably, the inequality (1/600)×Va<Vb<(1/2)×Va should be satisfied.

### Second Exemplary Embodiment

Concerning Examples 21 through 31, the pulse frequency of the second pulse P2 was changed, and the arc discharge duration and the supplied power per one pulse at the time of arc discharge were evaluated using a similar evaluation method to that of the above-discussed first exemplary embodiment.

### Example 21

The respective frequencies of the first pulse P1 and the second pulse P2 were both set at 0.5 kHz, and the relationship between a peak voltage value Va of the first pulse P1 and a peak voltage value Vb of the second pulse P2 was set at Vb/Va=(1/10).

### Examples 22 to 31

Examples 22 through 31 are the same as Example 21, apart from the respective pulse frequencies of the first pulse P1 and the second pulse P2 being the frequencies shown in Table 2 below.

### <Evaluation Method>

At a time when the pulse frequency of the second pulse P2 was 1.0 kHz, the arc discharge duration is given by tb, and the supplied power is given by Pb. Based thereon, the arc discharge duration and the supplied power of Examples 21 through 31 were evaluated in relation to each other. More specifically, the following evaluation criteria were followed.

### (Duration Evaluation Criteria)

Evaluation A: Duration was 100×tb or greater.

Evaluation B: Duration was 10×tb or greater, and less than 100×tb.

Evaluation C: Duration was 1×tb or greater, and less than 10×tb.

Evaluation D: Duration was 0.1×tb or greater, and less than 1×tb.

### (Supplied Power Evaluation Criteria)

Evaluation A: Supplied power was less than 1.5×Pb.

Evaluation B: Supplied power was 1.5×Pb or greater, and less than 3.×Pb.

Evaluation C: Supplied power was 3.0×Pb or greater, and less than 5.0×Pb.

Evaluation D: Supplied power was 5.0×Pb or greater, and less than 8.0×Pb.

The evaluation results are shown in Table 2.

TABLE 2

| | Pulse Frequency of | Evaluation | |
|---|---|---|---|
| | Second Pulse | Arc Discharge | Supplied |
| | [kHz] | Duration | Power |
| Example 21 | 0.5 | D | A |
| Example 22 | 1.0 | C | A |
| Example 23 | 5.0 | C | A |
| Example 24 | 10.0 | B | B |
| Example 25 | 50.0 | B | B |
| Example 26 | 100.0 | B | B |
| Example 27 | 150.0 | B | B |
| Example 28 | 200.0 | A | B |
| Example 29 | 300.0 | A | B |
| Example 30 | 400.0 | A | C |
| Example 31 | 410.0 | A | D |

As understood from Table 2, an evaluation of A for Examples 28 through 31 was revealed when the pulse frequency of the second pulse P2 resided in a range from 200.0 to 410.0 kHz, an evaluation of B for Examples 24 through 27 was revealed when the pulse frequency resided in a range from 10.0 to 150.0 kHz, an evaluation of C for Examples 22 and 23 was revealed when the pulse frequency resided in a range from 1.0 to 5.0 kHz, and an evaluation of D for Example 21 was revealed when the pulse frequency was 0.5 kHz.

In relation to supplied power, an evaluation of A for Examples 21 through 23 was revealed when the pulse frequency of the second pulse P2 resided in a range from 0.5 to 5.0 kHz, an evaluation of B for Examples 24 through 29 was revealed when the pulse frequency resided in a range from 10.0 to 300.0 kHz, an evaluation of C for Example 30 was revealed when the pulse frequency was 400.0 kHz, and an evaluation of D for Example 31 was revealed when the pulse frequency was 410.0 kHz.

When the evaluation results are considered comprehensively, it is understood that, preferably, the pulse frequency of the second pulse P2 should be within a range from 1 to 400 kHz, more preferably, should be within a range from 10 to 400 kHz, and particularly preferably, should be within a range from 200 to 300 kHz.

### Third Exemplary Embodiment

Concerning Examples 41 through 48, a relationship between a peak current value Ib of the second pulse P2 and a peak current value Ic of the third pulse P3 was changed, and the arc discharge duration and the supplied power per one pulse at the time of arc discharge were evaluated using a similar evaluation method to that of the above-discussed first exemplary embodiment.

### Example 41

The frequencies of the first pulse P1 and the second pulse P2 were both set at 100 kHz, and the relationship between a peak current value Ib of the second pulse P2 and a peak current value Ic of the third pulse P3 was set at Ib=Ic.

### Examples 42 through 48

Examples 42 through 48 are the same as Example 41, apart from the relationships between the peak current value Ib of the second pulse P2 and the peak current value Ic of the third pulse P3 being as shown in Table 3 below.

### <Evaluation Method>

At a time when the relationships between the peak current value Ib of the second pulse P2 and the peak current value Ic of the third pulse P3 was Ib=(5/12)Ic, the arc discharge duration is given by tc, and the supplied power is given by Pc. Based thereon, the arc discharge duration and the supplied power of Examples 41 through 48 were evaluated in relation to each other. More specifically, the following evaluation criteria were followed.

### (Duration Evaluation Criteria)

Evaluation A: Duration was 100×tc or greater.

Evaluation B: Duration was 10×tc or greater, and less than 100×tc.

Evaluation C: Duration was 1×tc or greater, and less than 10×tc.

Evaluation D: Duration was 0.1×tc or greater, and less than 1×tc.

### (Supplied Power Evaluation Criteria)

Evaluation A: Supplied power was less than 1.5×Pc.

Evaluation B: Supplied power was 1.5×Pc or greater, and less than 3.0×Pc.

Evaluation C: Supplied power was 3.0×Pc or greater, and less than 5.0×Pc.

Evaluation D: Supplied power was 5.0×Pc or greater, and less than 8.0×Pc.

The evaluation results are shown in Table 3.

TABLE 3

Evaluation

| | | Arc Discharge | Supplied |
|---|---|---|---|
| | Ib/Ic | Duration | Power |
| Example 41 | 1 | A | D |
| Example 42 | 11/12 | A | D |
| Example 43 | 10/12 | A | C |
| Example 44 | 9/12 | A | C |
| Example 45 | 8/12 | A | C |
| Example 46 | 7/12 | B | B |
| Example 47 | 6/12 | B | A |
| Example 48 | 5/12 | C | A |

As understood from Table 3, in relation to arc discharge duration, an evaluation of A for Examples 41 through 45 was revealed when Ib/Ic resided in a range from (1) to (8/12), an evaluation of B for Examples 46 and 47 was revealed when Ib/Ic was (7/12) and (6/12), and an evaluation of C for Example 48 was revealed when Ib/Ic was (5/12).

In relation to supplied power, an evaluation of A for Examples 47 and 48 was revealed when Ib/Ic was (6/12) and (5/12), an evaluation of B for Example 46 was revealed when Ib/Ic was (7/12), an evaluation of C for Examples 43 through 45 was revealed when Ib/Ic resided in a range from (10/12) to (8/12), and an evaluation of D for Examples 41 and 42 was revealed when Ib/Ic was (1) and (11/12).

When the evaluation results are considered comprehensively, it is understood that the upper limit of the peak current value Ib of the second pulse P2, preferably, should be (10/12)×Ic, more preferably, should be (8/12)×Ic, and particularly preferably, should be (6/12)×Ic.

### Fourth Exemplary Embodiment

Concerning examples 51 through 58, a relationship between the current conduction period Tit of the current of the second pulse P2 and the current conduction period Ti3 of the current of the third pulse P3 was changed, and the arc discharge duration and the supplied power per one pulse at the time of arc discharge were evaluated using a similar evaluation method to that of the above-discussed first exemplary embodiment.

### Example 51

The frequencies of the first pulse P1 and the second pulse P2 were both set at 100 kHz, and the relationship between the current conduction period Tit of the current of the second pulse P2 and the current conduction period Ti3 of the current of the third pulse P3 was set at Ti2/Ti3=(1/150).

### Examples 52 through 58

Examples 52 through 58 are the same as Example 51, apart from the relationships between the current conduction period Ti2 of the current of the second pulse P2 and the current conduction period Ti3 of the current of the third pulse P3 being as shown in Table 4 below.

### <Evaluation Method>

At a time when the relationship between the current conduction period Ti2 of the current of the second pulse P2 and the current conduction period Ti3 of the current of the third pulse P3 was Ti2=(1/100)Ti3, the arc discharge duration is given by td, and the supplied power is given by Pd. Based thereon, the arc discharge duration and the supplied power of Examples 51 through 58 were evaluated in relation to each other. More specifically, the following evaluation criteria were followed.

### (Duration Evaluation Criteria)

Evaluation A: Duration was 100×td or greater.

Evaluation B: Duration was 10×td or greater, and less than 100×td.

Evaluation C: Duration was 1×td or greater, and less than 10×td.

Evaluation D: Duration was 0.1×td or greater, and less than 1×td.

### (Supplied Power Evaluation Criteria)

Evaluation A: Supplied power was less than 1.5×Pd.

Evaluation B: Supplied power was 1.5×Pd or greater, and less than 3.0×Pd.

Evaluation C: Supplied power was 3.0×Pd or greater, and less than 5.0×Pd.

Evaluation D: Supplied power was 5.0×Pd or greater, and less than 8.0×Pd.

The evaluation results are shown in Table 4.

TABLE 4

Evaluation

| | | Arc Discharge | Supplied |
|---|---|---|---|
| | Ti2/Ti3 | Duration | Power |
| Example 51 | 1/150 | C | A |
| Example 52 | 1/100 | C | A |
| Example 53 | 1/50 | B | B |
| Example 54 | 1/20 | A | B |
| Example 55 | 1/12 | A | B |
| Example 56 | 3/6 | A | B |
| Example 57 | 4/6 | A | C |
| Example 58 | 5/6 | A | C |

As understood from Table 4, in relation to arc discharge duration, an evaluation of A for Examples 54 through 58 was revealed when Ti2/Ti3 resided in a range from (1/20) to (5/6), an evaluation of B for Example 53 was revealed when Ti2/Ti3 was (1/50), and an evaluation of C for Examples 51 and 52 was revealed when Ti2/Ti3 was (1/150) and (1/100).

In relation to supplied power, an evaluation of A for Examples 51 and 52 was revealed when Ti2/Ti3 was (1/150) and (1/100), an evaluation of B for Examples 53 through 56 was revealed when Ti2/Ti3 resided in a range from (1/50) to (3/6), and an evaluation of C for Examples 57 and 58 was revealed when Ti2/Ti3 was (4/6) and (5/6).

When the comparison results are considered comprehensively, it is understood that, preferably, the inequality (1/100)×Ti3<Ti2<(5/6)×Ti3 should be satisfied, more preferably, the inequality (1/50)×Ti3<Ti2<(2/3)×Ti3 should be satisfied, and particularly preferably, the inequality (1/20)×Ti3<Ti2<(1/2)×Ti3 should be satisfied.

Although certain preferred embodiments of the present invention have been shown and described in detail, it should be understood that various changes and modifications may be made to the embodiments without departing from the scope of the present invention as set forth in the appended claims.

What is claimed is:

1. A discharge device comprising:
a pair of electrodes;
a pulse generator for applying pulses between the pair of electrodes; and
a pulse controller for controlling the pulse generator to generate electric discharges between the pair of electrodes;
wherein the pulse controller comprises:
a first controller for applying at least one high-energy first pulse between the pair of electrodes in a first interval to promote a discharge breakdown between the pair of electrodes; and
a second controller for applying at least two second pulses, which are lower in energy than the first pulse, between the pair of electrodes in a second interval after the discharge breakdown has occurred between the pair of electrodes, thereby to maintain the discharge breakdown between the pair of electrodes.

2. The discharge device according to claim 1, wherein the first pulse has a peak voltage value Va and the second pulse has a peak voltage value Vb, the peak voltage value Va and the peak voltage value Vb being related to each other as follows:
Va>Vb.

3. The discharge device according to claim 2, wherein the second pulse has a pulse frequency ranging from 1 to 400 kHz.

4. The discharge device according to claim 1, wherein the first controller applies at least two of the first pulses between the pair of electrodes in the first interval; and
the first pulse has a pulse period Ta and the second pulse has a pulse period Tb, the pulse period Ta and the pulse period Tb being related to each other as follows:
Ta≧Tb.

5. The discharge device according to claim 1, wherein the first pulse is applied as a high-energy third pulse between the pair of electrodes in a third interval from a stage in which the discharge breakdown has occurred between the pair of electrodes to the second interval.

6. The discharge device according to claim 5, wherein the first pulse has a peak voltage value Va, the third pulse has a peak voltage value Vc, the first pulse has a current conduction period Ti1, and the third pulse has a current conduction period Ti3, the peak voltage value Va, the peak voltage value Vc, the current conduction period Ti1, and the current conduction period Ti3 satisfying the following relationships:
Va>Vc
Ti1<Ti3.

7. The discharge device according to claim 6, wherein the second pulse has a peak current value Ib, the third pulse has a peak current value IC, the second pulse has a current conduction period Ti2, and the third pulse has a current conduction period Ti3, the peak current value Ib, the peak current value Ic, the current conduction period Ti2, and the current conduction period Ti3 satisfying the following relationships:
Ib≦Ic
Ti2<Ti3.

8. The discharge device according to claim 7, wherein the second pulse has a pulse frequency ranging from 1 to 400 kHz.

9. The discharge device according to claim 5, wherein at least two of the first pulses are applied in the first interval;
at least two of the third pulses are applied in the third interval; and
each of the first pulses has a pulse period Ta, each of the second pulses has a pulse period Tb, and each of the third pulses has a pulse period Tc, the pulse period Ta, the pulse period Tb, and the pulse period To satisfying the following relationships:
Ta=Tc
Tb≦Tc.

10. The discharge device according to claim 5, wherein the number of the third pulses ranges from 1 to 10.

11. The discharge device according to claim 1, wherein the number of the first pulses is up to 10.

12. The discharge device according to claim 1, wherein the pulse generator includes a pulse generating circuit having a DC power supply and a transformer and a switch, which are connected in series to each other across the DC power supply, and the pulse controller turns on the switch to store an induced energy in the transformer and turns off the switch to generate the pulses in a secondary winding of the transformer.

13. The discharge device according to claim 12, wherein the second controller changes an inductance of at least a primary winding of the transformer at a starting time of the second interval.

14. The discharge device according to claim 13, wherein the starting time of the second interval is a time when a preset period has elapsed from a starting time of the first interval.

15. The discharge device according to claim 13, wherein the pulse controller comprises:
a discharge breakdown detector for detecting when the discharge breakdown occurs between the pair of electrodes, based on the voltage between the pair of electrodes;
wherein the starting time of the second interval is a time when a preset period has elapsed from a time at which the discharge breakdown detector detects when the discharge breakdown occurs between the pair of electrodes.

16. The discharge device according to claim 12, wherein the second controller changes a period to store the induced energy in the transformer at a starting time of the second interval.

17. The discharge device according to claim 16, wherein the starting time of the second interval is a time when a preset period has elapsed from a starting time of the first interval.

18. The discharge device according to claim 16, wherein the pulse controller comprises:
a discharge breakdown detector for detecting when the discharge breakdown occurs between the pair of electrodes, based on the voltage between the pair of electrodes;
wherein the starting time of the second interval is a time when a preset period has elapsed from a time at which the discharge breakdown detector detects when the discharge breakdown occurs between the pair of electrodes.

19. The discharge device according to claim 1, wherein:
among the pair of electrodes, one of the electrodes is a central electrode that is insulated by an insulator, and another of the electrodes is a ground electrode;
the central electrode and the ground electrode are separated from each other and are in contact with a surface of the insulator; and
creeping discharge is carried out via the surface of the insulator.

20. The discharge device according to claim 1, wherein:
among the pair of electrodes, one of the electrodes is a central electrode that is insulated by an insulator, and another of the electrodes is a ground electrode;
the central electrode and the ground electrode are arranged in confronting relation to each other with a space therebetween; and
spark discharge is carried out between the central electrode and the ground electrode.
